(19) United States
(12) Patent Application Publication
(10) Pub. No.: US 2015/0288788 A1
(43) Pub. Date: Oct. 8, 2015

(54) Mobile Device Management

(71) Applicant: Stephen Y Liu, Dallas, TX (US)

(72) Inventor: Stephen Y Liu, Dallas, TX (US)

(21) Appl. No.: 14/247,422

(22) Filed: Apr. 8, 2014

(51) Int. Cl. H04M 1/02; H04W 4/02; G08B 5/36

(52) U.S. Cl. CPC H04M 1/0264; G08B 5/36; H04W 4/02

(57) ABSTRACT

The illustrative embodiments described herein provide a computer-implemented method, apparatus, and computer program product for managing operation of a mobile device. A presence of vehicular travel is identified. Distracted use indicators associated with a user of the mobile device are monitored. The distracted use indicators include at least one of a pattern of distracted movement and an input violation entered into the mobile device by the user. The input violation includes at least one common input from a set of common inputs. At least one rule from a set of modified usage rules is implemented if a distracted use indicator is identified. The set of modified usage rules limits usability of the mobile device. If a distracted use indicator is not identified, implementation of the set of modified usage rules is optionally prevented for a duration of travel of the vehicle.

### BACKGROUND OF THE INVENTION

1. Field of the Invention

The present invention relates generally to management of mobile devices. Still more particularly, the present invention relates to managing operation of mobile devices using distracted use indicators.

2. Background Art

Examples of mobile devices include, for example but without limitation, smart phones, tablets, digital media players, navigation devices, and laptop computers. Portability of mobile devices provides users with instantaneous access to information and entertainment. In addition, mobile devices allow users to remain in constant contact with others via phone call, text message, or social media applications. And, with the constant technological advancements and elimination of cost barriers, the ownership of mobile devices has increased dramatically. Conservative estimates now show that the number of mobile devices in America exceeds the entire population.

Mobile devices have been integrated into virtually every aspect of some users' daily lives. Many technophiles often check their mobile devices immediately upon waking, right before bed, and countless times in between without regard to common sense or etiquette. Those enthusiastic users are often unable or unwilling to curb the use of their mobile devices and, as a result, their failure to exercise restraint has resulted in the creation of laws as a means to enforce safe usage of mobile devices. Infractions, however, often go unnoticed and are therefore rarely enforced. Technological safeguards should be introduced.

### BRIEF SUMMARY OF THE INVENTION

An illustrative embodiment provides a computer implemented method for managing operation of a mobile device associated with a vehicle. A presence of vehicular travel associated with the vehicle is identified. A user of the mobile device is a driver of the vehicle or a passenger of the vehicle. Distracted use indicators associated with the user of the mobile device are monitored. The distracted use indicators include at least one of a pattern of distracted movement and an input violation entered into the mobile device by the user. The input violation comprises at least one common input from a set of common inputs. In response to identifying at least one distracted use indicator, at least one rule from a set of modified usage rules is implemented. The set of modified usage rules limits usability of the mobile device. Optionally, in response to failing to identify at least one distracted use indicator, implementation of the set of modified usage rules is prevented for duration of travel of the vehicle.

In another illustrative embodiment, a computer program product includes a computer usable medium including computer usable program code for managing operation of a mobile device associated with a vehicle. The computer program product includes computer usable program code for identifying a presence of vehicular travel associated with the vehicle. A user of the mobile device is a driver of the vehicle or a passenger of the vehicle. The computer usable program code monitors for distracted use indicators associated with the user of the mobile device. The distracted use indicators include at least one of a pattern of distracted movement and an input violation entered into the mobile device by the user. The input violation comprises at least one common input from a set of common inputs. The computer usable program code implements at least one rule from a set of modified usage rules in response to identifying at least one distracted use indicator. The set of modified usage rules limits usability of the mobile device. The computer usable program code for optionally preventing implementation of the set of modified usage rules for a duration of travel of the vehicle in response to a failure to identify at least one distracted use indicator.

In still another illustrative embodiment, a mobile computing device is provided. The mobile computing device includes a bus system; a communications system coupled to the bus system; and a memory connected to the bus system; and a processing unit coupled to the bus system. The memory includes computer usable program code. The processing unit executes the computer usable program code to manage operation of the mobile device associated with a vehicle. The processor unit further executes the computer usable program code to identify a presence of vehicular travel associated with the vehicle. The processor unit further executes the computer usable program code to monitor for distracted use indicators associated with a user of the mobile device. A user of the mobile device is a driver of the vehicle or a passenger of the vehicle. The distracted use indicators include at least one of a pattern of distracted movement and an input violation entered into the mobile device by the user. The input violation comprises at least one common input from a set of common inputs. The processor unit further executes the computer usable program code to implement at least one rule from a set of modified usage rules in response to identifying at least one distracted use indicator. The set of modified usage rules limits usability of the mobile device. The processor unit further executes the computer usable program code to optionally prevent implementation of the set of modified usage rules for a duration of travel of the vehicle in response to a failure to identify at least one distracted use indicator.

### BRIEF DESCRIPTION OF THE SEVERAL VIEWS OF THE DRAWINGS

The novel features believed characteristic of the invention are set forth in the appended claims. The illustrative embodiments, as well as a preferred mode of use, further objectives and advantages thereof, will best be understood by reference to the following detailed description when read in conjunction with the accompanying drawings, wherein:

FIG. 1 is a pictorial representation of a network data processing system in which illustrative embodiments may be implemented;

FIG. 2 is a block diagram of a data processing system in which illustrative embodiments may be implemented;

FIG. 3 is a block diagram of a mobile device in which illustrative embodiments may be implemented;

FIG. 4 is image data for identifying a pattern of distracted use in accordance with an illustrative embodiment;

FIG. 5 is a flowchart of a process for managing operation of a mobile device in accordance with an illustrative embodiment;

FIG. 6 is a flowchart of a process for identifying patterns of distracted movement in accordance with an illustrative embodiment; and

FIG. 7 is a flowchart of a process for identifying input violations in input data in accordance with an illustrative embodiment.

### DETAILED DESCRIPTION OF THE PREFERRED EMBODIMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

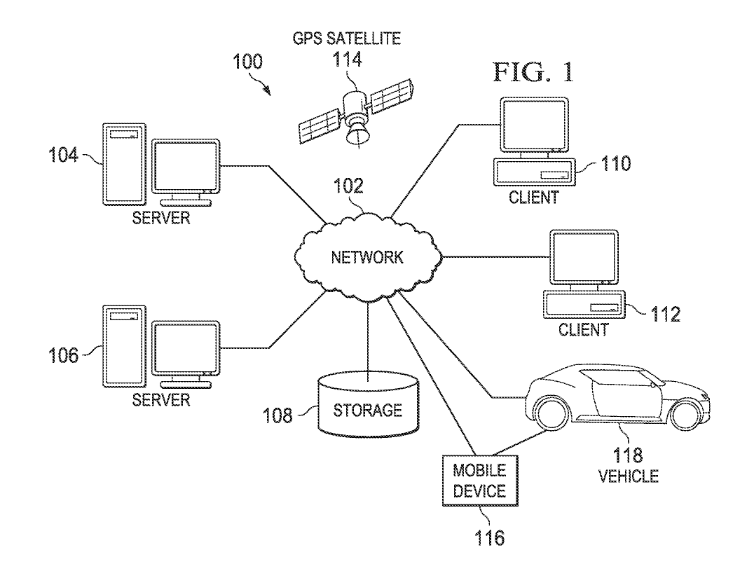

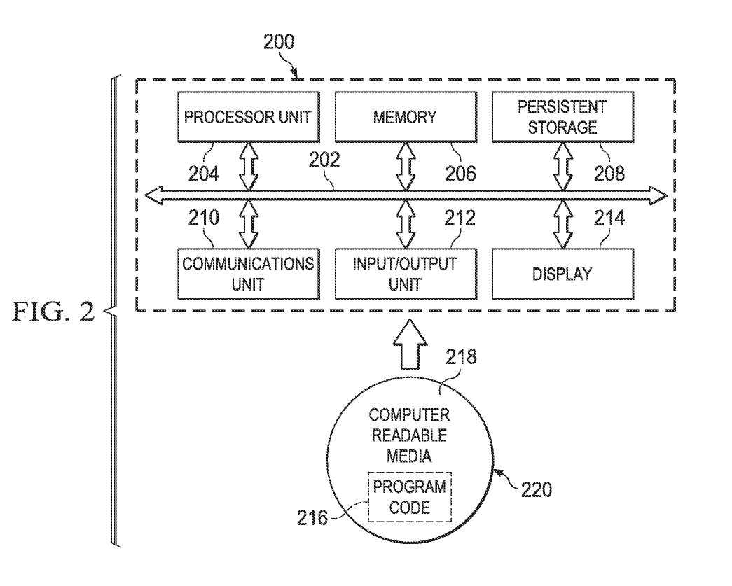

With reference now to the figures and in particular with reference to FIG. 1 and FIG. 2, exemplary diagrams of data processing environments are provided in which illustrative embodiments may be implemented. It should be appreciated that FIG. 1 and FIG. 2 are only exemplary and are not intended to assert or imply any limitation with regard to the environments in which different embodiments may be implemented. Many modifications to the depicted environments may be made.

FIG. 1 depicts a representation of a network of data processing systems in which illustrative embodiments may be implemented. Network data processing system 100 is a network of computers in which the illustrative embodiments may be implemented in whole or in part. Network data processing system 100 includes network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110 and 112 connect to network 102. Clients 110 and 112 may be, for example, personal computers or network computers. In the depicted example, server 104 provides data, such as boot files, operating system images, and applications to clients 110 and 112. Clients 110 and 112 are clients to server 104 in this example. Network data processing system 100 may include additional servers, clients, and other devices not shown.

In addition, network data processing system 100 includes one or more global positioning system (GPS) satellites, such as, but without limitation, GPS satellite 114. GPS satellite 114 is one or more satellites integrated into the global positioning system that enables one or more mobile devices, such as mobile device 116 to provide geo-location services. Further, mobile device 116 may also be communicatively coupled directly to a vehicle, such as, but not limited to, vehicle 118. The communications link may be any form of wired or wireless communications link, currently existing or later developed.

In this illustrative example in FIG. 1, mobile device 116 is a mobile phone that may be in the possession of a user traveling in vehicle 118. However, the embodiments are not limited to a mobile device in the form of a mobile phone. Mobile device 116 may also be a smart watch, a tablet computer, a laptop computer, a wearable computer with an optical head-mounted display, such as Google Glass®, or any other type of mobile device. Additionally, the illustrative example in FIG. 1 depicts vehicle 117 as a passenger car. However, the embodiments are not limited to passenger cars. Vehicle 118 may be any type of vehicle including but not limited to a pickup truck, bus, commercial truck, motorcycle, motorboat, bicycle, moped, aircraft, or any other type of currently existing or later developed vehicle.

Using GPS satellite 114, or any other form of speed detection system, mobile device 116 is capable of determining that a user in possession of mobile device 116 is actually or presumptively traveling in vehicle 118. The detection of distracted use indicators in a presence of vehicular travel would result in the implementation of modified usage rules restricting or otherwise modifying the usability of mobile device 116. If the user is not displaying distracted use indicators, then the user is identifiable as a passenger and would be permitted to operate mobile device 116 without restriction or modification for the duration of the travel.

Program code located in network data processing system 100 may be stored on a computer recordable storage medium and downloaded to a data processing system, mobile device 116, or other device for use. For example, program code may be stored on a computer recordable storage medium on server 104 and downloaded to client 110 over network 102 for use on client 110.

In the depicted example, network data processing system 100 includes the Internet with network 102 including a worldwide collection of networks and gateways that use the Transmission Control Protocol/Internet Protocol (TCP/IP) suite of protocols to communicate with one another. At the core of the Internet is a backbone of high-speed data communication lines between major nodes or host computers, consisting of numerous commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The burden of safe mobile device usage currently rests with users of mobile devices who have varying levels of responsibility, self-control, maturity, and common sense. Thus self-regulation by users is inconsistent and unreliable. To some extent, laws have been created to curb unsafe usage of mobile devices, such as the use of mobile devices by drivers. For example, most states prohibit mobile device usage by drivers in active school zones. In addition, some states prohibit use of mobile devices in the absence of hands-free headsets, while other states have no such restrictions. These laws are difficult to enforce and thus fail to serve as an adequate deterrent.

These legislative safeguards recognize that drivers operating mobile devices are unnecessarily distracted and pose a great risk to themselves, their passengers and any person unlucky enough to be in the vicinity. When traveling at high rates of speed, fractions of a second spent texting or otherwise interacting with mobile devices could have tragic consequences. In fact, studies have shown that drivers who are also using mobile devices have reaction times similar to those of drunk drivers. Similarly, operating a mobile device while attempting to maneuver through crowded parking lots with limited lines of sight distracts the driver from the myriad of nearby pedestrians and vehicles.

For the foregoing reasons, the embodiments disclosed herein recognize that using a mobile device while concurrently driving a vehicle is dangerous. Currently existing technological safeguards prevent users from operating a mobile device in a moving vehicle. The illustrative embodiments recognize that currently available solutions are undesirable because they prevent legitimate uses of mobile devices by passengers. The embodiments disclosed herein further recognize a need for technological safeguards that differentiate between drivers and passengers of a moving vehicle.

Consequently, the embodiments disclosed herein are directed to providing additional technological safeguards for insuring that the mobile devices are being used safely or not used at all. The solution proposed herein differentiates drivers and passengers based on the demonstration of distracted use indicators that are unique to drivers. Upon detecting distracted use indicators, modified usage rules would be implemented that limit or otherwise modify the usability of the mobile device. For example, the modified usage rules may prevent use and/or access to the mobile device, or simply prevent the use of certain applications or features, such as texting or game play.

Accordingly, one embodiment provides for a computer-implemented method, apparatus, and computer program product for managing mobile device usage. Monitoring for a distracted use indicator is performed. The distracted use indicator may include a pattern of distracted movement or an input violation of one or more common inputs. In response to identifying a distracted use indicator in a presence of vehicular travel, one or more modified usage rules are implemented.

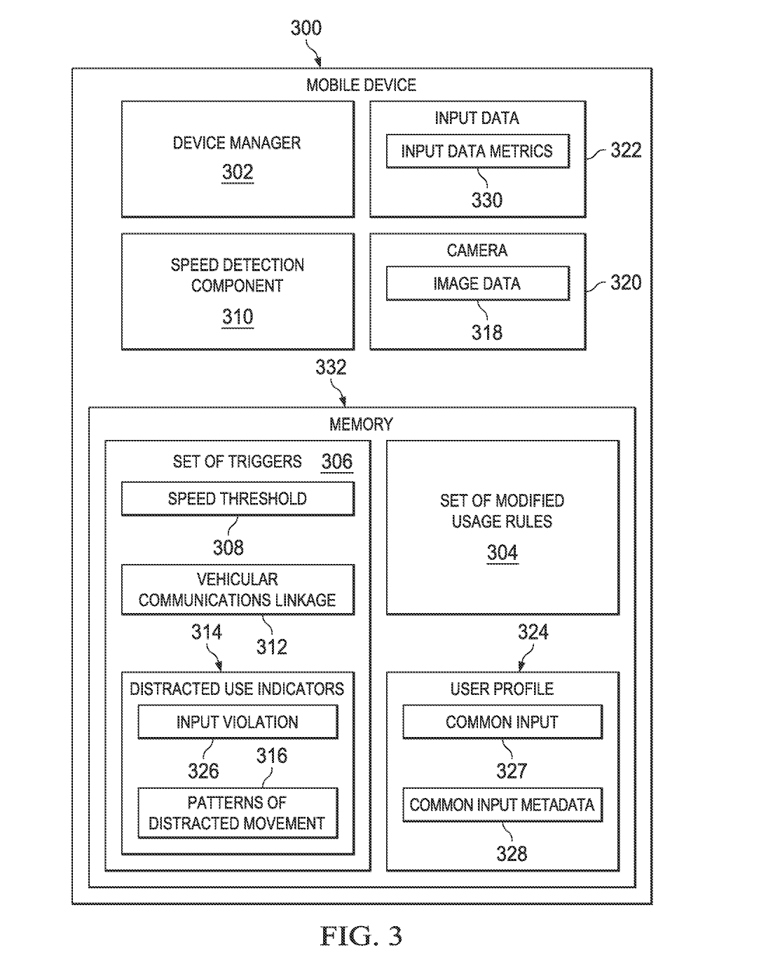

FIG. 3 is a block diagram of a mobile device in which illustrative embodiments may be implemented. Mobile device 300 is a mobile device, such as mobile device 116 in FIG. 1. In this illustrative example in FIG. 3, mobile device 300 is a smart phone. In alternate embodiments mobile device 300 may be a laptop, a tablet computer, a smart watch, or any other mobile computing device.

Mobile device 300 includes device manager 302. Device manager 302 is a component of mobile device 300 for managing operation of mobile device 300. Device manager 302 may be implemented as software, hardware, or a combination of software and hardware. Device manager 302 manages the operation of mobile device 300 with reference to set of modified usage rules 304. Set of modified usage rules 304 is one or more rules restricting or otherwise modifying the usability of mobile device 300. As used herein, the term “set” means one or more. Thus, set of modified usage rules 304 may include a single rule for managing usability of mobile device 300, as well as two or more rules for managing usability of mobile device 300. The rules defined in set of modified usage rules 304 may be established by state or federal law, or by a cell phone service provider. Additionally, set of modified usage rules 304 may be created by any entity, including but not limited to users or third parties, such as an employer, an owner of a vehicle, parent, guardian, or caretaker of underage users.

Examples of rules included in set of modified usage rules 304 may include, but are not limited to, an outright restriction on the use of mobile device 300. Alternatively, set of modified usage rules 304 may include a selective restriction that prevents a user from accessing certain applications or features while permitting unrestricted access to others. Thus, a user may be prevented from texting but be permitted to place or receive emergency phone calls. Additionally, the manner in which a user may operate or otherwise interact with mobile device 300 may be modified. For example, set of modified usage rules 304 may prevent a user from texting with a keypad of mobile device 300 but may permit the user to dictate the content of the message. Further, certain applications may be specifically exempted from modification or restriction by set of modified usage rules 304, such as navigational applications or music applications.

Device manager 302 selects one or more rules for implementation in response to detecting one or more triggers in set of triggers 306. Set of triggers 306 is a collection of pre-defined events or conditions. In this illustrative embodiment in FIG. 3, set of triggers 306 is defined to enable device manager 302 to modify a driver's use of mobile device 300 in a moving vehicle by enabling differentiation of permissible and impermissible use of mobile device 300 in the presence of vehicular travel. Vehicular travel is an actual or presumptive state of movement facilitated by a vehicle. In other words, set of triggers 306 includes triggers for determining whether use of mobile device 300 is occurring while actually or presumptively in a state of movement by a vehicle, and triggers for differentiating use of mobile device 300 by drivers and passengers.

Set of triggers 306 includes speed threshold 308. In one non-limiting embodiment, speed threshold 308 is a trigger defined as a rate of travel that, when achieved, is indicative of vehicular travel. Thus, once device manager 302 detects mobile device 300 has achieved speed threshold 310, a presumption is made that the user in possession of mobile device 300 is traveling in a moving vehicle and a presence of vehicular travel has been identified. This presumption may be based on the fact that there are limits on the rate of unassisted human, bipedal movement. Rates of travel at or above those limits would be indicative of vehicular travel. As an example, speed threshold 308 may be set at twenty miles per hour but may be set higher or lower. Further, speed threshold 308 may include more granular requirements, including but not limited to maintaining a pre-selected speed for a minimum amount of time or distance.

In another embodiment, speed threshold 308 may take the form of a threshold change of speed over time, such as a rate of acceleration or deceleration. Thus, drivers in rush hour traffic who never attain a top speed that would otherwise be attributable to travel in a vehicle may still be in a presence of vehicular travel. For example, a rate of acceleration of deceleration in excess of average, unassisted human acceleration and/or deceleration is sufficient for establishing a presence of vehicular travel. In yet another embodiment, speed threshold 308 may be defined to include a pre-determined pattern of repeated acceleration and deceleration, regardless of rate. In this exemplary embodiment, repeated acceleration and deceleration in an absence of movement at a constant speed could be indicative of driving in rush hour traffic and still serve as a trigger for identifying a presence of vehicular travel.

Data usable for detecting speed threshold 308 may be provided by speed detection system 310. Speed detection system 310 is one or more components of mobile device 300 that may include software and/or hardware for obtaining travel-related data such as speed, acceleration, and deceleration. For example, speed detection system 310 may include a GPS system capable of interfacing with one or more GPS satellites, such as GPS satellite 114 in FIG. 1, for establishing a rate of travel by mobile device 300. Further, although less accurate, speed detection system 310 may include hardware and/or software to enable cell tower multilateration navigational techniques for use in determining a rate of vehicular travel. In another embodiment, speed detection system 310 may include accelerometers that measure acceleration and/or deceleration experienced by mobile device 300. Travel-related data may also be supplied to mobile device 300 by a vehicle in the event that mobile device 300 is communicatively coupled to the vehicle via a wired or wireless communications link.

A presence of vehicular travel may also be identified without consideration to actual movement if, for example, mobile device 300 is communicatively coupled to a vehicle. This presumption may obviate the need to collect and analyze travel-related data that may otherwise tax the resources of mobile device 300. As such, vehicular communications linkage 312 is another trigger that may be established for identifying a presence of vehicular travel.

In summary, device manager 302 may identify a presence of vehicular travel by detecting at least one of speed threshold 308 and vehicular communications linkage 312. As used herein, when used with a list of items, the term “at least one of” means that different combinations of one or more of the items may be used and only one of each item in the list may be needed. For example, “at least one of item A and item B” may include, without limitation, item A individually, item B individually, or items A and B in combination. Thus, with respect to FIG. 3, device manager 302 may identify a presence of vehicular travel in response to detecting either speed threshold 308 or vehicular communications linkage 312, or both speed threshold 308 and vehicular communications linkage 312. However, because vehicular communications linkage 312 may result in unnecessary restriction on the use of mobile device 300 by preventing use of mobile device 300 while parked or at a stoplight, such a trigger may be omitted in favor of speed threshold 308.

In an illustrative embodiment in FIG. 3, use of mobile device 300 in a presence of vehicular travel is insufficient to trigger the implementation of rules in set of modified usage rules 304 because passengers of vehicles would unnecessarily be limited in their use of mobile device 300. Instead, device manager 302 implements one or more rules in set of modified usage rules 304 for managing operation of mobile device 300 upon identifying distracted use indicators 314 in the presence of vehicular travel.

Distracted use indicators 314 are one or more triggers in set of triggers 306 for differentiating use of mobile device 300 by drivers and passengers. Users who are multi-tasking the operation of mobile device 300 and driving a vehicle display certain actions that are detectable and thus usable for triggering the implementation of set of modified usage rules 304. In particular, drivers who are also attempting to concurrently operation mobile device 300 exhibit a common pattern of movement characterized by repeated glancing between mobile device 300 and a point away from mobile device 300, such as the road, other vehicles, signs, and/or vehicle controls. In addition, users who are drivers attempting to operate mobile device 300 are unable to operate mobile device 300 in the same manner as if the user were simply a passenger. Passengers can operate mobile device 300 with both hands whereas the driver is generally limited to operating mobile device 300 with one had as the other hand is often found on the steering wheel.

In FIG. 3, distracted use indicators 314 include pattern of distracted movement 316. Pattern of distracted movement 316 is a trigger that is identifiable when a driver displays a particular action, namely glancing to and from mobile device 300 at a pre-defined rate or for a pre-determined number of times. Pattern of distracted movement 316 may be identified from image data 318. Image data 318 is data captured by camera 320 and may be in the form of a series of images or video. Camera 320 is a component of mobile device 300 for capturing photographs and/or videos.

Pattern of distracted movement 316 may be identified from image data 318 according to any currently existing or later developed technique. For example, image data 318 may be analyzed using currently available eye-tracking technology that identifies eye movements and determines the direction of a user's gaze. Thus, in response to detecting a threshold number of eye glances to and from mobile device 300, device manager 302 may identify pattern of distracted movement 316 from image data 318. Once pattern of distracted movement 316 is identified in the presence of vehicular travel, device manager 302 may implement one or more rules from set of modified usage rules 304.

In the previous example, device manager 302 monitors a user's gaze to detect pattern of distracted movements 316. However, in an alternate embodiment, device manager 302 may monitor for other movements indicative of distracted use of mobile device 300. For example, a position and movement of the driver's head could be used to identify pattern of distracted movement 316 from image data 318.

Monitoring a user operating mobile device 300 for pattern of distracted movement 316 has some inherent limitations. For example, in low light situations camera 320 may be unable to capture a viable image of the user. Additionally, because operating camera 320 depletes a battery of mobile device 300 more rapidly, power constraints may also dictate that usage of camera 320 would be unadvisable. Furthermore, instances may arise where camera 320 is accidentally or purposefully obscured. In these scenarios, device manager 302 may monitor input data 322 in a presence of vehicular travel to identify another form of distracted use indicator for managing operation of mobile device 300.

Input data 322 is data generated by a user during the operation of mobile device 300. In other words, input data 322 is entered into mobile device 300 by user in real time. Input data 322 may include any words or phrases, or sequences of characters generated by a user for completing text messages, emails, or website addresses. In addition, input data 322 may include, unlocking patterns or passwords for unlocking mobile device 300, spoken phrases, or sequence of specific actions to navigate menu items for launching applications, or other forms of data generated by a user through the operation of mobile device 300.

Over time, device manager 302 may create common input 327 from input data 322. Restated, common input 327 is a collection of inputs derived from input data 322. In one embodiment, common input 327 is a list of popular or frequently used inputs generated by a user operating mobile device 300. Common input 327 may include, for example and without limitation a password to unlock mobile device 300, a name of the user's most frequently texted contact, the user's most commonly used salutation, a website address, and any other number of commonly used inputs.

Inputs from input data 322 may be added to common input 327 after a user has generated the input a threshold number of times, or according to some other selection criteria. More frequently used inputs replace less frequently used inputs, which insures that common input 327 does not become stale and filled with unused data. Alternatively, common input 327 may be an ever-increasing list with newly added elements once sufficient use of those elements is detected. In yet another embodiment, common input 327 may be re-populated with new inputs on a periodic basis, such as every day, week, or month, with the most commonly generated inputs from the previous period. This continual evolution of common input 327 over time recognizes that a user's language patterns evolve over time and that commonly used words and phrases change, as do passwords.

Common input 327 may also take the form of a pre-populated list of commonly used words or phrases universal to a group of mobile device owners based on geographic location, language, educational level, age group, or any other characteristic. The pre-populated list may include words culled from periodicals, social media sites, text messages, emails, or any other form of media and periodically updated as language trends change. Additionally, common input 327 may be a combination of a particular user's most commonly generated inputs and a pre-populated list of commonly used words or phrases.

Input data 322 is associated input data metrics 330. Input data metrics 330 is data that describes the manner in which input data 322 is generated by a user operating mobile device 300. Input data metrics 330 may be any one or more type of measurable characteristic captured during the generation of input data 322 including but not limited to an amount of time for completing each input in input data 322, a length of delay between a completed input and the start of another, a length of time between the input of specific characters, a rate of typographical error, a length of a keypress, a length of time required for launching an application from a home screen, a length of time to complete an unlocking pattern, or any other measurable characteristic.

Each input in common input 327 is associated with one or more values in common input metadata 328. Common input metadata 328 is data derived from input data metrics 330. Specifically, common input metadata 328 is a collection of values captured and/or processed such that they describe the manner in which a user of mobile device 300 generates an input from common input 327 in an undistracted fashion. Thus, in a non-limiting embodiment, each value in common input metadata 328 is captured in an absence of vehicular travel and collected over time using a sufficient number of measurements to create an accurate portrayal of how the user would ordinarily use mobile device 300 to generate the associated input from common input 327 in an undistracted fashion. In other words, with reference to the embodiment disclosed in FIG. 3, common input metadata 328 describes how a user of mobile device 300 would generate associated inputs of common input 327 when the user is not also attempting to drive a vehicle.

In a simplistic example, common input metadata 328 is a list of average completion times for each input in common input 327. Each time value in common input metadata 328 is an average calculated over a period of time from values derived from input data metrics 330 as the user generated input data 322 on mobile device 300. To prevent a user from skewing the time values in common input metadata 328 to allow for unintended use of mobile device 300 in the presence of vehicular travel, the completion times used for generating each time value in common input metadata 328 is captured in the absence of vehicular travel, at least initially. Any form of mathematical computation or processing may be applied for calculating the average completion times in common input metadata 328. For example, outliers may be omitted, standard deviations may be applied, and the like.

Device manager 302 may reference common input metadata 328 to identify input violation 326 for triggering the implementation of set of modified usage rules 304. Input violation 326 is a distracted use indicator identifiable when a user operating mobile device 300 generates an input from common input data 327 in a manner that fails to comport with common input metadata 328. In operation, device manager 302 monitors input data 322 in view of common input 327.

In response to identifying an input from common input 327 present in input data 322, device manager 302 compares input data metrics 330 for that input with an associated value from common input metadata 328. If input data metrics 330 for that input does not comport with the value from common input metadata 328, then device manager identifies input violation 326 for triggering set of modified usage rules 304. As an example, common input 327 may include the word “Hello”. Common input metadata 328 may associate an average completion time with that word having a value of two seconds. If device manager 302 detects the word “Hello” in input data 322 in a presence of vehicular travel, then device manager 302 compares input data metrics 330 captured for that word in the presence of vehicular travel with the value stored in common input metadata 328. If input data metrics 330 for the word “Hello” has a value of four seconds, then a comparison of that value with the two second value of common input metadata 328 would result in an identification of input violation 326. However, if input data metrics 330 for the word “Hello” has a value of two seconds, then device manager 302 may identify the user as a passenger and prevent implementation of set of modified usage rules 304 for the duration of travel.

A duration of travel is a period of time spent in a vehicle traveling from one location to another where a passenger is unlikely to become a driver. A duration of travel encompasses a presence of vehicular travel, but also includes periods of stillness, which often occurs when a vehicle is idling in traffic or at a stoplight. In a simple embodiment, a duration of travel may be for the length of time that a vehicle's engine is running. Alternatively, a duration of travel may be characterized by periods of stillness interspersed with a presence of vehicular travel, but where the periods of stillness do not exceed some pre-selected length of time or some other threshold.

Common input 327 and common input metadata 328 are stored in user profile 324. User profile 324 is a profile storing data specific to a particular user of mobile device 300. In most instances, mobile device 300 is owned and operated by a single user, in which case device manager 302 creates user profile 324 for storing common input data 327 and common input metadata 328 for that user. Device manager 302 may create additional temporary and/or permanent user profiles specific to other users. For example, mobile device 300 may be owned by a wife and historical user data 324 may relate to her use of mobile device 300. The wife's husband may also use mobile device 300, in which case device manager 302 would create a separate user profile with its own historical user data specific to the husband.

Device manager 302 may create additional user profiles in the event that device manager 302 determines that more than one user operates mobile device 300. For example, use of mobile device 300 that results in the generation of input data 322 having input data metrics 330 that consistently violates common input metadata 328, or input data 322 that fails to share sufficient similarity with common input 327 may be indicative of another user of mobile device 300. In this scenario, device manager 302 creates another user profile and begins capturing data for populating a new user profile for the second user.

In one embodiment, device manager 302 monitors for both input violation 326 and pattern of distracted movement 316. Although this embodiment is likely to produce the most accurate determination of distracted use of mobile device 300, such a course of action could consume unacceptable levels of processing power and battery. Therefore, device manager 302 may be configured to monitor for one type of distracted use indicator and monitor for another type of distracted use indicator in the event that results are inconclusive or non-existent. For example, a user of mobile device 300 may not be the owner of mobile device 300. A simple facial recognition software program could make this determination. As such, historical user data 324 may be less accurate in facilitating the detection of input violation 326 as the user is generating input data 322. Consequently, device manager 302 may decide to monitor for patterns of distracted movement 316 rather than monitor for input violation 326. In another scenario, a user may be operating mobile device 300 in the presence of vehicular travel at night. Camera 320 may be unable to capture usable images for identifying pattern of distracted movement 316. Consequently, device manager 302 would rely upon identifying input violation 326 from input data 322 instead of monitoring for patterns of distracted movement 316.

Battery levels may also dictate the manner in which device manager 302 monitors for distracted use indicators 314. Usage of camera 320 could cause an unacceptable rate of battery depletion so that battery levels below a certain threshold could cause device manager 302 to favor detection of input violation 326 over detection of pattern of distracted movement 316.

In another embodiment, inconclusive results from a first method of identifying one type of distracted use indicators could cause device manager 302 to monitor for another type of distracted use indicator. In an example where a user of mobile device 300 is reading a lengthy email and only occasionally interacting with mobile device 300, device manager 302 may be unable to detect input violation 326. Device manager 302 may then search for pattern of distracted movement 316 in image data 318 instead.

In one embodiment, device manager 302 disables, at least temporarily, any active rules from set of modified usage rules 304 in the absence of vehicular travel. Thus, drivers of vehicles may operate mobile device 300 without restriction or modification at stoplights or in parking lots or at other times when the driver is not technically driving in a distracted, impaired, and/or unsafe manner.

In the event that device manager 302 may have instituted one or more rules from set of modified usage rules 304 in error, such as on a mobile device of a passenger in a moving vehicle, and a request has been made by the passenger to disable any and all active rules from set of modified usage rules 304, then device manager 302 may present a challenge to the user for disabling set of modified usage rules 304. In an illustrative embodiment, device manager 302 presents a challenge to the passenger in the form of one or more inputs from common input 327 for completion by the user. If the user is able to complete the one or more inputs by generating input data 322 having input data metrics 330 complying with the associated values in common input metadata 328, then device manager 302 may disable set of modified usage rules 304.

In another embodiment, device manager 302 may present a challenge to the passenger for detecting pattern of distracted movement 316. In this embodiment, device manager 302 may request that the user direct attention to mobile device 300 for a pre-determined period of time, uninterrupted. If the user glances away from mobile device 300 before completion of the challenge, as in the instance where the user is a driver checking traffic, then the user fails and set of modified usage rules 304 remains in effect.

Although previously disclosed embodiments discuss implementing set of modified usage rules 304 in response to identifying one or more of distracted use indicators 314 in a presence of vehicular travel, in an alternate embodiment device manger 302 may automatically implement set of modified usage rules 304 in a presence of vehicular travel and remove set of modified usage rules 304 only after a user requests removal of set of modified usage rules 304 and successfully completes a challenge to prove that mobile device 300 is being used in an undistracted manner. As previously discussed, the challenge may require the user to prove that mobile device 300 can be used in such a way so as not to display one or more of distracted use indicators 314 in the presence of vehicular travel. Challenges that are completed successfully result in the removal of set of modified usage rules 304.

Although the discussion presented with respect to FIG. 3 describes the management of a smartphone, in an alternate embodiment, device manager 302 may be integrated into a computer of a vehicle for controlling use of a navigation system, entertainment system, or any other vehicular system operable by a user while the user is driving the vehicle.

Data for managing the operation of mobile device 300 may be stored in memory 332. Memory 332 is any form of currently existing or later developed memory, including but not limited to memory 206 in FIG. 2. In an alternate embodiment, the data may be stored remotely from mobile device 300 in a networked storage device, such as storage 108 in FIG. 1. The data may then be accessed via a network, such as network 102 in FIG. 1.

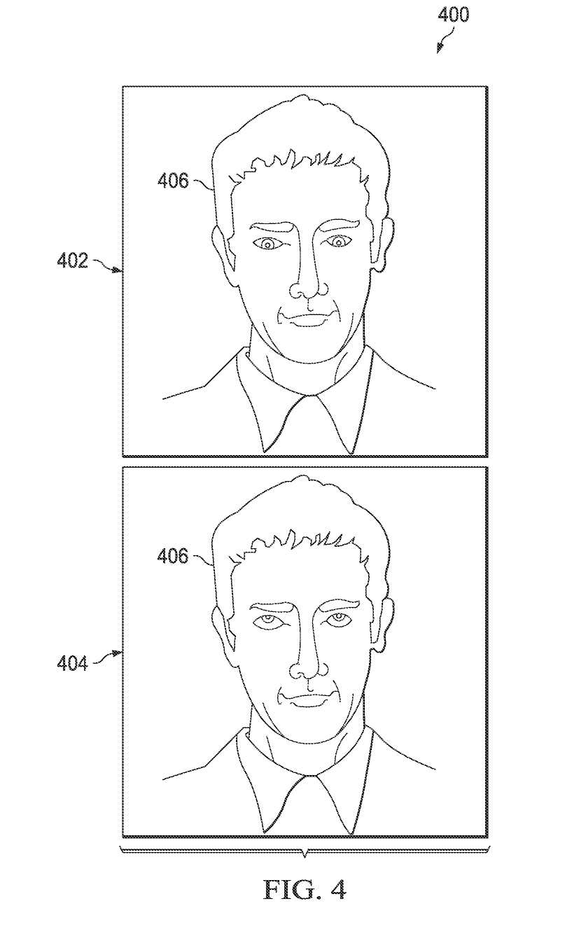

FIG. 4 is image data for identifying a pattern of distracted use in accordance with an illustrative embodiment. Image data 400 is image data, such as image data 318 in FIG. 3. In this illustrative example, image data 400 includes images 402 and 404 but in an alternate embodiment, image data 400 may include additional images (not shown).

In an illustrative embodiment in FIG. 4, images 402 and 404 are captured by a camera of a mobile device, such as camera 320 of FIG. 3, in the presence of vehicular travel. In image 402, user 406 is looking at the mobile device. In image 404 user 406 is looking away from the mobile device. Individually, neither image 402 nor image 404 is necessarily indicative of distracted use of a mobile device by user 406. For example, image 402 depicts user 406 viewing and/or interacting with the mobile device. User 406 in image 402 may be reading or responding to an email or text message, playing a game, consuming streaming media, or otherwise utilizing the mobile device. In an example where image 402 is one of a series of similar images or video depicting user 406 operating the mobile device undistracted and uninterrupted for a pre-selected period of time, then user 406 is not displaying a pattern of distracted movement. Optionally, user 406 may be identified as a passenger in the vehicle based on this undistracted use of the mobile device. As a passenger of the vehicle, a subsequent display of a distracted use indicator would not trigger the implementation of one or more rules from a set of modified usage rules for the duration of travel.

With reference now to image 404, user 406 is depicted as focusing attention away from the mobile device that captured image 404. In the event where image 404 is representative of a series of similar images all depicting user 406 focusing attention away from the mobile device, user 406 would not appear to be using the mobile device. Regardless of whether user 406 is a driver or passenger, implementation of modified usage rules would be unnecessary.

However, when viewed together, the combination of images 402 and 404 depicts an action that can be described as a glance to and from the mobile device that captured images 402 and 404. This action alone may be sufficient to serve as a pattern of distracted use for initiating one or more rules in a set of modified usage rules when such action is detected in the presence of vehicular travel. However, this action may also be a driver checking the time or silencing an incoming call so as to continue safe driving. Thus, in another embodiment, user 406 must repeat this action until a threshold number of repetitions has been detected to be identifiable as a pattern of distracted use. Alternatively, the pattern of distracted use may be defined as a glancing action that is repeated at a pre-defined rate. These criteria are defined in patterns of distracted movement, such as patterns of distracted movement 316 in FIG. 3.

In this illustrative example in FIG. 4, a device manager uses existing eye-tracking technology to track the gaze of user 406. When the device manager detects that user 406 has achieved the specified rate or number of glances, a pattern of distracted movement has been identified. In one embodiment, the identification of the pattern of distracted movement in the presence of vehicular travel triggers the implementation of one of a set of modified usage rules, such as set of modified usage rules 304 in FIG. 3.

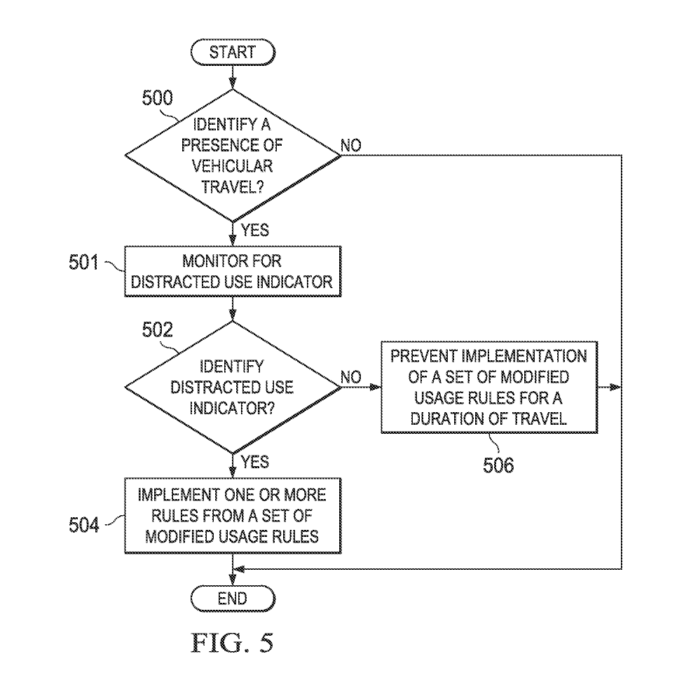

FIG. 5 is a flowchart of a process for managing operation of a mobile device in accordance with an illustrative embodiment. The process depicted in FIG. 5 may be implemented by a device manager, such as device manager 302 in FIG. 3.

The process begins by making the determination as to whether vehicular travel is detected (step 500). As previously discussed, the device manager may make this determination based upon at least one of a detection of a vehicular communications link between the mobile device and a vehicle, or by detecting the achievement of a speed threshold.

At step 500, if vehicular travel is not identified, then the process terminates. Termination occurs because device management would be unnecessary. However, if vehicular travel is identified at step 500, then the process monitors for a distracted use indicator (step 501). A determination is made as to whether a distracted use indicator is identified (step 502). If a distracted use indicator is identified, then the process implements one or more modified usage rules (step 504) and the process terminates.

However, if at step 502 the determination is made that a distracted used indicator is not identified for a pre-selected period of time, then implementation of modified usage rules are prevented for the duration of the travel (step 506), and the process terminates. Step 506 insures that a passengers use of a mobile device is unaffected if at some point in time the passenger begins to use the mobile device in a manner that displays distracted use indicators. This scenario may arise where a passenger's use of a mobile device is interrupted, such as when the passenger is attempting to operate the mobile device while having a conversation with a driver or other passenger of the vehicle.

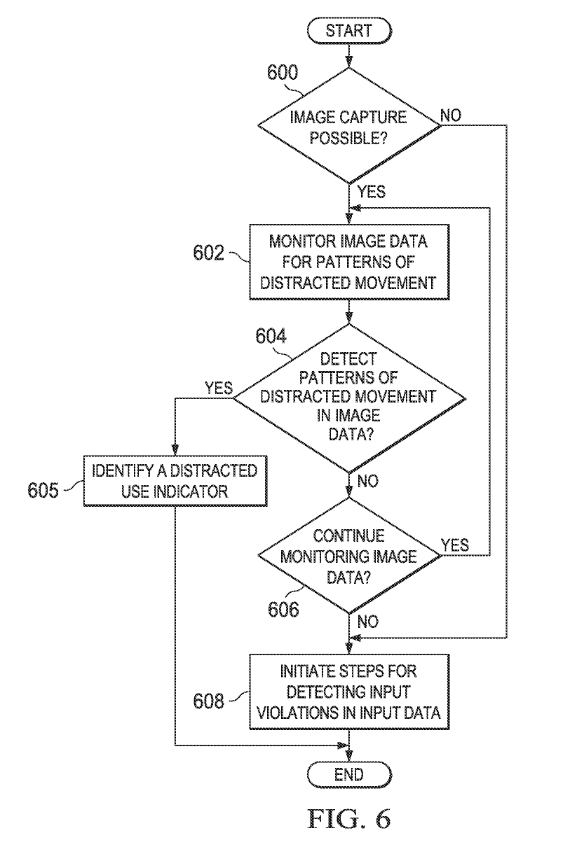

FIG. 6 is a flowchart of a process for identifying patterns of distracted movement in accordance with an illustrative embodiment. The process depicted in FIG. 6 may be implemented by a device manager, such as device manager 302 in FIG. 3. The process shown in FIG. 6 identifies distracted use indicators and may be implemented in step 502 in FIG. 5 above.

The process begins by making a determination as to whether image capture is possible (step 600). If the determination is made that image capture is possible, then the process monitors image data for a pattern of distracted movement (step 602). The pattern of distracted movement may take the form of distracted eye movements or distracted head movements, as described above in FIG. 4.

The process continues by making a determination as to whether patterns of distracted movement are detected in the image data (step 604). If patterns of distracted movement are detected in the image data, then a distracted use indicator is identified (step 605) and the process terminates. However, if patterns of distracted movement are not detected in image data at step 604, then the process makes a determination as to whether monitoring of image data should continue (step 606). If monitoring of image data continues, then the process returns to step 602.

However, if the process makes the determination that monitoring of image data should not continue, the process initiates steps for detecting input violations input data (step 608) and the process terminates thereafter.

Returning now to step 600, if the process makes the determination that image capture is not possible, then the process continues to step 608, with the process terminating thereafter.

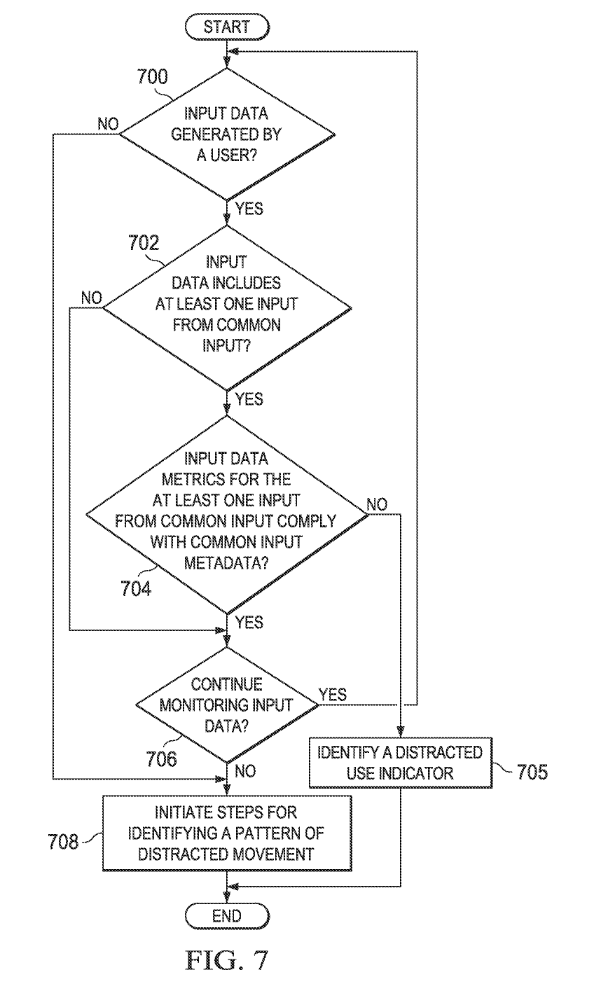

FIG. 7 is a flowchart of a process for identifying input violations in input data in accordance with an illustrative embodiment. The process depicted in FIG. 7 may be implemented by a device manager, such as device manager 302 in FIG. 3. The process shown in FIG. 7 identifies distracted use indicators and may be implemented in step 502 in FIG. 5 above.

The process begins by making a determination as to whether input data has been generated by a user (step 700). If the process makes the determination that a user has generated input data, then the process makes a determination as to whether the input data includes at least one input from common input (step 702). If the input data includes at least one input from common input, then a determination is made as to whether input data metrics for the at least one input of common input comports with common input metadata (step 704). If input data metrics for the at least one input from common input does not comport with common input metadata, then a distracted use indicator is identified (step 705) and the process terminates. In particular, the distracted use indicator detected in this example is an input violation such as input violation 326 in FIG. 3.

Returning to step 702, if a determination is made that the input data does not include at least one input from common input, the process makes a determination as to whether to continue monitoring input data (step 706). If the process continues monitoring input data, then the process returns to step 700. However, if the process does not to continue monitoring input data at step 706, then the process initiates steps for identifying a pattern of distracted movement (step 708) and the process terminates.

With reference to step 704, if the process makes the determination that input data metrics for the at least one element from common input complies with the common input metadata, the process continues to step 706.

At step 700, if input data has not been generated by a user, then the process continues to step 708.

The processes described in FIG. 6 and FIG. 7 may be carried out individually, in sequence, or concurrently. The actual implementation of the processes described in FIGS. 6 and 7 depend upon the particular embodiment selected.

In accordance with the foregoing, the illustrative embodiments described herein provide a computer-implemented method, apparatus, and computer program product for managing mobile device usage. Monitoring for a distracted use indicator is performed. The distracted use indicator may include a pattern of distracted movement or an input violation of one or more common inputs. In response to identifying a distracted use indicator in a presence of vehicular travel, one or more modified usage rules are implemented.

A notable benefit of implementing technological safeguards against the unsafe use of mobile devices by drivers of vehicles as described hereinabove is that the users are relieved of the burden of knowing where mobile device usage is unadvisable or illegal. Further, users who would otherwise disregard mobile device usage restrictions no longer have the ability to place the burden of rule enforcement on the appropriate authorities.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention may take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing operation of a mobile device associated with a vehicle, the computer implemented method comprising:
identifying a presence of vehicular travel associated with the vehicle;
monitoring for distracted use indicators associated with a user of the mobile device, wherein a user of the mobile device is a driver of the vehicle or a passenger of the vehicle, wherein the distracted use indicators comprises at least one of a pattern of distracted movement and an input violation entered into the mobile device by the user, and wherein the input violation comprises at least one common input from a set of common inputs;
responsive to identifying at least one distracted use indicator, implementing at least one rule from a set of modified usage rules, wherein the set of modified usage rules limits usability of the mobile device; and
responsive to failing to identify at least one distracted use indicator, optionally preventing implementation of the set of modified usage rules for a duration of travel of the vehicle.

2. The computer implemented method of claim 1 further comprising:
monitoring image data from a camera associated with the mobile device for patterns of distracted movement; and
responsive to detecting the pattern of distracted movement in the image data, identifying the distracted use indicator.

3. The computer implemented method of claim 1 further comprising:
monitoring user generated input data on the mobile device in real time during operation of the mobile device;
responsive to a determination that the user generated input data comprises at least one input corresponding with common input, determining if input data metrics for the at least one input complies with common input metadata; and
identifying a distracted use indicator in response to the determination that the input data metrics for the at least one input fails to comply with the common input metadata.

4. The computer implemented method of claim 1 further comprising:
receiving vehicular travel data from the vehicle by a vehicular communications linkage associated with the mobile device, wherein vehicular travel data identifies the presence of vehicular travel associated with the vehicle or an absence of vehicular travel associated with the vehicle.

5. The computer implemented method of claim 1 further comprising:
detecting a speed threshold trigger in a set of triggers, wherein the speed threshold trigger indicates the presence of vehicular travel, and wherein the speed threshold is a rate of travel by the vehicle that is maintained for a minimum amount of time or a rate of travel by the vehicle that is maintained over a minimum distance.

6. The computer implemented method of claim 1 further comprising:
detecting a speed threshold trigger in a set of triggers, wherein the speed threshold trigger indicates the presence of vehicular travel, wherein the speed threshold trigger is a rate of acceleration by the vehicle or a rate of deceleration of the vehicle.

7. The computer implemented method of claim 1 wherein implementing the at least one rule from the set of modified usage rules further comprises:
disabling a first set of applications associated with the mobile device, wherein the user is prevented from accessing the first set of applications; and
enabling a second set of applications associated with the mobile device, wherein the user is permitted to utilize the second set of applications.

8. The computer implemented method of claim 1 further comprising:
detecting a threshold number of input occurring within a predetermined period of time to form the input violation.

9. A computer program product comprising:
a computer usable medium including computer usable program code for managing operation of a mobile device associated with a vehicle, said computer program product comprising:
computer usable program code for identifying a presence of vehicular travel associated with the vehicle;
computer usable program code for monitoring for distracted use indicators associated with the user of the mobile device, wherein a user of the mobile device is a driver of the vehicle or a passenger of the vehicle, wherein the distracted use indicators comprises at least one of a pattern of distracted movement and an input violation entered into the mobile device by the user, wherein the input violation comprises at least one common input from a set of common inputs;
computer usable program code for implementing at least one rule from a set of modified usage rules in response to identifying at least one distracted use indicator, wherein the set of modified usage rules limits usability of the mobile device; and
computer usable program code for optionally preventing implementation of the set of modified usage rules for a duration of travel of the vehicle in response to a failure to identify at least one distracted use indicator.

10. The computer program product of claim 9 further comprising:
computer usable program code for monitoring image data from a camera associated with the mobile device for patterns of distracted movement; and
computer usable program code for identifying the distracted use indicator in response to detecting the pattern of distracted movement in the image data.

11. The computer implemented method of claim 9 further comprising:
computer usable program code for monitoring user generated input data on the mobile device in real time during operation of the mobile device;
computer usable program code for determining if input data metrics for the at least one input complies with common input metadata in response to a determination that the user generated input data comprises at least one input corresponding with common input; and
computer usable program code for identifying a distracted use indicator in response to the determination that the input data metrics for the at least one input fails to comply with the common input metadata.

12. The computer implemented method of claim 9 further comprising:
computer usable program code for receiving vehicular travel data from the vehicle by a vehicular communications linkage associated with the mobile device, wherein vehicular travel data identifies the presence of vehicular travel associated with the vehicle or an absence of vehicular travel associated with the vehicle.

13. The computer implemented method of claim 9 further comprising:
computer usable program code for detecting a speed threshold trigger in a set of triggers, wherein the speed threshold trigger indicates the presence of vehicular travel, and wherein the speed threshold is a rate of travel by the vehicle that is maintained for a minimum amount of time or a rate of travel by the vehicle that is maintained over a minimum distance.

14. The computer implemented method of claim 9 further comprising:
computer usable program code for detecting a speed threshold trigger in a set of triggers, wherein the speed threshold trigger indicates the presence of vehicular travel, wherein the speed threshold trigger is a rate of acceleration by the vehicle or a rate of deceleration of the vehicle.

15. A mobile computing device comprising:
a bus system;
a communications system coupled to the bus system;
a memory connected to the bus system, wherein the memory includes computer usable program code; and
a processing unit coupled to the bus system, wherein the processing unit executes the computer usable program code to manage operation of the mobile device associated with a vehicle, wherein the processor unit further executes the computer usable program code to identify a presence of vehicular travel associated with the vehicle;
wherein the processor unit further executes the computer usable program code to monitor for distracted use indicators associated with the user of the mobile device, wherein a user of the mobile device is a driver of the vehicle or a passenger of the vehicle, wherein the distracted use indicators comprises at least one of a pattern of distracted movement and an input violation entered into the mobile device by the user, wherein the input violation comprises at least one common input from a set of common inputs;
wherein the processor unit further executes the computer usable program code to implement at least one rule from a set of modified usage rules in response to identifying at least one distracted use indicator, wherein the set of modified usage rules limits usability of the mobile device; and
wherein the processor unit further executes the computer usable program code to optionally prevent implementation of the set of modified usage rules for a duration of travel of the vehicle in response to a failure to identify at least one distracted use indicator.

16. The mobile computing device of claim 15 wherein the processor unit further executing the computer usable program code to monitor image data from a camera associated with the mobile device for patterns of distracted movement, and wherein the processor unit further executes the computer usable program code to identify the distracted use indicator in response to detecting the pattern of distracted movement in the image data.

17. The mobile computing device of claim 15 wherein the processor unit further executing the computer usable program code to monitor user generated input data on the mobile device in real time during operation of the mobile device; wherein the processor unit further executing the computer usable program code to determine if input data metrics for the at least one input complies with common input metadata in response to a determination that the user generated input data comprises at least one input corresponding with common input; and wherein the processor unit further executing the computer usable program code to identify a distracted use indicator in response to the determination that the input data metrics for the at least one input fails to comply with the common input metadata.

18. The mobile computing device of claim 15 wherein the processor unit further executing the computer usable program code to receive vehicular travel data from the vehicle by a vehicular communications linkage associated with the mobile device, wherein vehicular travel data identifies the presence of vehicular travel associated with the vehicle or an absence of vehicular travel associated with the vehicle.

19. The mobile computing device of claim 15 wherein the processor unit further executing the computer usable program code to detect a speed threshold trigger in a set of triggers, wherein the speed threshold trigger indicates the presence of vehicular travel, and wherein the speed threshold is a rate of travel by the vehicle that is maintained for a minimum amount of time or a rate of travel by the vehicle that is maintained over a minimum distance.

20. The mobile computing device of claim 15 wherein the processor unit further executing the computer usable program code to detect a speed threshold trigger in a set of triggers, wherein the speed threshold trigger indicates the presence of vehicular travel, wherein the speed threshold trigger is a rate of acceleration by the vehicle or a rate of deceleration of the vehicle.
